(19) United States
(12) Patent Application Publication
(10) Pub. No.: US 2023/0341338 A1
(43) Pub. Date: Oct. 26, 2023

(54) DEVICE AND METHOD FOR THE TRANSMISSION MEASUREMENT OF REFLECTED MICROWAVES

(71) Applicant: TEWS Elektronik GmbH, Hamburg (DE)

(72) Inventor: Ewa Felber, Pinneberg (DE)

(73) Assignee: TEWS Elektronik GmbH & Co. KG, Hamburg (DE)

(21) Appl. No.: 17/799,391

(22) PCT Filed: Jan. 20, 2021
(86) PCT No.: PCT/EP2021/051131

§ 371 Date: Aug. 12, 2022

(30) Foreign Application Priority Data
Feb. 14, 2020 (DE) 10 2020 103 978.6

(51) Int. Cl. G01N 22/00

(52) U.S. Cl. CPC G01N 22/00

(57) ABSTRACT

A device for transmission measurement of a measurement object by measuring and evaluating reflected microwaves includes a microwave generator and a transmitting and receiving unit connected to the microwave generator to emit microwave radiation onto the measurement object and to receive radiation reflected from the measurement object. The transmitting and receiving unit includes an individual, dually polarized antenna. A reflector is provided and includes a polarizer to rotate a polarization of the radiation reflected from the measurement object in relation to incident radiation. The reflector is positioned on a side of the measurement object facing away from the transmitting and receiving unit. A modulator is included for the transmitting and receiving unit to determine at least one of: (i) an amplitude; and (ii) a phase position between the emitted and reflected radiation. The modulator is configured as an Q/I modulator.

### CROSS REFERENCE TO RELATED INVENTION

This application is a national stage application pursuant to 35 U.S.C. § 371 of International Application No. PCT/EP2021/051131, filed on Jan. 20, 2021, which claims priority to, and benefit of, German Patent Application No. 10 2020 103 978.6, filed Feb. 14, 2020, the entire contents of which are hereby incorporated by reference.

### TECHNOLOGICAL FIELD

The present invention relates to a device and a method for the transmission measurement with reflected microwaves. The disclosed measurement method is based on the fact that physical parameters of an object are determined by means of transmitted microwave radiation. The microwaves enter into the measurement object and are reflected by it or by a reflector on the rear side of the measurement object.

### BACKGROUND

An example of a known measurement method is described by way of example in EP 1 407 254 B1. The measurement method is employed for a series of measurement objects, such as wood, tobacco, and food to determine the moisture content. An exact knowledge of the moisture content is often important for the running of the production process and allows a reliable control of the output quality of the product.

The physical principle underlying the measurement is based on the complex-valued relative permittivity of the measurement object. Using the Kramers-Kronig relation, the relationship, for example, between the complex permittivity and optical characteristic variables, such as the refractive index and absorption coefficient, can be represented. Roughly speaking, the dielectric properties of a material result to the effect that the real part of the complex permittivity refers to the ability of a material to store electrical energy and the imaginary part describes a loss of dielectric energy in the medium. By measuring both of these variables, the water content and the density of the material can be determined very exactly. In principle, substances other than water in the measurement object can also be evaluated.

In general, it has proven effective for the measurement to provide a reflector for the transmitted radiation. After passing through the medium, this radiation is reflected back by the reflector to a receiving antenna. For this purpose, it is provided that a lambda ¼ polarizer or, more precisely, a ¼*(2n+1)(n∈ [symbol] ) lambda polarizer is used, with which the polarization of the reflected radiation is rotated in relation to that of the incident radiation. In this manner, it is possible to differentiate between the radiation reflected by the surface of the measurement object and the radiation reflected after passing through the measurement object, since they have a different polarization.

An arrangement and a measurement method in which two antennas are worked with is known from the already mentioned document EP 1 407 254 B1. A transmitting antenna directs the emitted microwave radiation toward the measurement object, while a second, independent receiving antenna receives the reflected radiation and passes it on for analysis. Such a setup with two antennas is required, since, when using only one antenna, crosstalk between the antenna input and output occurs, which distorts the reflected radiation. This crosstalk between the input and output of the antennas makes a costly setup with two separate antennas necessary.

The object of the present invention is to provide a device and a measurement method that require the simplest setup possible.

### BRIEF SUMMARY OF THE INVENTION

The device according to the invention is provided and intended for the transmission measurement of a measurement object. The device measures microwaves reflected by the measurement object, whether these are microwaves reflected by the surface or after passage through the measurement object. The reflected microwaves are measured and evaluated.

In an embodiment, the disclosed device according comprises microwave generator, which provides microwaves with a preset frequency or in a predetermined frequency band. A fixed frequency or a frequency that changes over time can be used. The device according to the invention also comprises a transmitting and receiving unit, which is connected to the microwave generator and transmits microwave radiation onto the measurement object and receives reflected radiation from it. The transmitting and receiving unit preferably comprises a directional characteristic directed toward the measurement object, which allows it to direct large portions of the applied microwaves onto the measurement object. The device according to the invention also comprises a reflector on a side of the measurement object facing away from the transmitting and receiving unit, which reflector has a polarizer with which the polarization of the reflected radiation is rotated in relation to the incident radiation. By the rotation or respectively by the change of the polarization, the polarizer serves to differentiate the microwave radiation reflected back by the polarizer or respectively reflector from other radiation, in particular from radiation reflected by the surface of the measured item. Furthermore, the device comprises a modulator for the transmitting and receiving unit, which determines an amplitude and a phase position between the emitted and reflected radiation. The modulator allows the comparison between the radiation passing through the measurement object and the emitted radiation. In this manner, both the attenuation and the shift of the radiation can be detected and thus, in a manner known per se, the complex, relative permittivity and thus variables in the measurement object, such as moisture and density, can be calculated.

The use according to the invention of a modulator allows the signals to be separated sufficiently precisely. This is a great advantage compared to the solution used in the prior art, in which a signal path is provided with an attenuation element and a phase shifter in order to adapt the characteristic of this channel precisely to the characteristic of the measuring channel (compare, for example, EP 1 407 254 B1).

The device according to the invention is preferably configured so that the transmitting and receiving unit has one common antenna. A common antenna illustrates the effort required in both hardware and evaluation for this device. The use of a modulator and in particular a Q/I modulator allows crosstalk between the input and output signals to be suppressed when using one common antenna. The Q/I modulator, also referred to as a Q/I demodulator, allows the phase ϕ and the amplitude A to be calculated from the I/Q signals. These I/Q signals are the output signals from two mixers which are in quadrature to each other. This leads to the I/Q outputs of the Q/I modulator having a phase shift of 90°, so that the phase position and/or the amplitude can preferably be determined from the I/Q signals over wide ranges, regardless of the operating point. Crosstalk leads to a direct-current offset of the I/Q signals, which can be measured and eliminated during a first calibration of the system.

In an embodiment, a reference signal, which originates from the microwave generator, just like the signal for the transmitting and receiving unit, is applied to the modulator.

In another embodiment, the microwave generator comprises an oscillator, the signal of which is applied to a splitter, the output signals of which serve as reference signals and as input signals for the transmitting and receiving unit. Furthermore, a phase-locked loop (PLL) is preferably provided for the reference signal and/or the input signal to the transmitting and receiving unit and provides a stable frequency. Preferably, one oscillator is employed for two phase-locked loops so that their signals run phase-synchronously. Preferably, a signal processor for the reference signal and/or for the input signal of the transmitting and receiving unit can also be present. With the signal processor, the signals can be processed with regard to amplitude, frequency, and phase position in each channel or in only one channel. For this purpose, the signal processor has one or more of the following assemblies: Amplifier, low-pass, and attenuator. In this case, it is preferable that two signal processors are provided.

Additionally, a phase shifter for the reference signal and/or the input signal of the transmitting and receiving unit can be provided. The phase shifter can be provided as a separate component or the desired phase shift is set digitally in the phase-locked loop. This phase shifter can be set, for example, during an initial calibration of the device so that the offsets of the I and Q signals originating from the crosstalk between the input and output of the microwave antenna are lessened/reduced and/or kept the same. As a result, the crosstalk can be removed more easily.

The reflector, which reflects the incident microwave radiation with a phase rotation, is preferably configured as a ¼ (2n+1) lambda waveplate. Such a waveplate is often referred to for short as a lambda ¼ reflector. The phase position is rotated by the reflector by 90° in relation to the incident phase, which entails a maximum precision of the phase position.

In a preferred embodiment, the Q/I modulator has two mixers which are in quadrature to each other. These mixers are each fed by an input signal, wherein a signal that is phase-shifted by 90° is applied to one of the mixers. In this way, the mixers generate two signals which are rotated by 90° in relation to each other and are applied to the mixers fed by an input signal.

In an embodiment, the Q/I modulator reliably generates, regardless of the operating point, values for I and Q signal which are transformed in phase and amplitude.

The object according to the invention is also achieved by a method for the transmission measurement of a measurement object. The method measures and evaluates reflected microwaves. For this purpose, microwave radiation is emitted onto the measurement object and radiation reflected from it is received with an antenna. After going through the measurement object, the polarization of the reflected radiation is rotated in relation to the incident radiation and the reflected radiation is received, wherein the amplitude and/or phase position between the emitted and reflected radiation are determined. The particular point is that the microwave beams are transmitted and the reflected microwave radiation is received by a transmitting and receiving unit. The amplitude and/or phase position of the reflected radiation is determined in a Q/I modulator, wherein for this purpose a reference signal for the Q/I modulator is preferably applied. The reference signal and the signal of the reflected radiation allow the Q/I modulator to precisely determine the change in amplitude and/or phase of the reflected radiation.

### BRIEF DESCRIPTION OF THE DRAWINGS

The present invention is described in detail below with reference to several figures. In the figures:

FIG. 1 schematically illustrates an embodiment of a transmitting and receiving unit which is directed toward a measurement object;

FIG. 2 schematically illustrates an embodiment of a measuring device;

FIG. 3 schematically illustrates the embodiment of the measuring device from FIG. 2 in greater detail;

FIG. 4a schematically illustrates an embodiment of a I/Q signal modulator generating I and Q signals from an input signal;

FIG. 4b graphically illustrates the I and Q signals generated from FIG. 4a shifted 90° relative to each other;

FIG. 5 schematically illustrates a prior art embodiment of the signal paths during a measurement with two antennas;

FIG. 6 schematically illustrates an example of the radiation path through the measurement object and the reflector;

FIG. 7a schematically illustrates an example of a radiation path between the transmitting and receiving unit, the measured item, and the reflector;

FIG. 7b schematically illustrates another example of a radiation path between the transmitting and receiving unit, the measured item, and the reflector; and

FIG. 7c schematically illustrates another example of a radiation path between the transmitting and receiving unit, the measured item, and the reflector.

### DETAILED DESCRIPTION OF THE INVENTION

FIG. 1 shows a transmitting and receiving unit 10, which directs microwave radiation 12 onto a measurement object 14. The incident microwave radiation 12 is reflected by a reflector 16 and received as reflected radiation 18 by the transmitting and receiving unit. Input signals 20 and output signals 22 are connected with the antenna (not shown) of the transmitting and receiving unit 10. As indicated by the arrow 24, crosstalk of the signals takes place between the input 20 and the output 22. This means that the input signals make a direct contribution to the measured output signals. The antenna used in the transmitting and receiving unit 10 is an antenna that has a very good directional characteristic, so that a lot of the signal is radiated in the direction of the measured item and crosstalk 24 is relatively small. If the crosstalk signal 24 was large, however, it would be a problem during digitization. In such a case, the large offset would fill the bits of the AD converter and as a result impair its availability for the measurement signal, reducing the overall achievable precision.

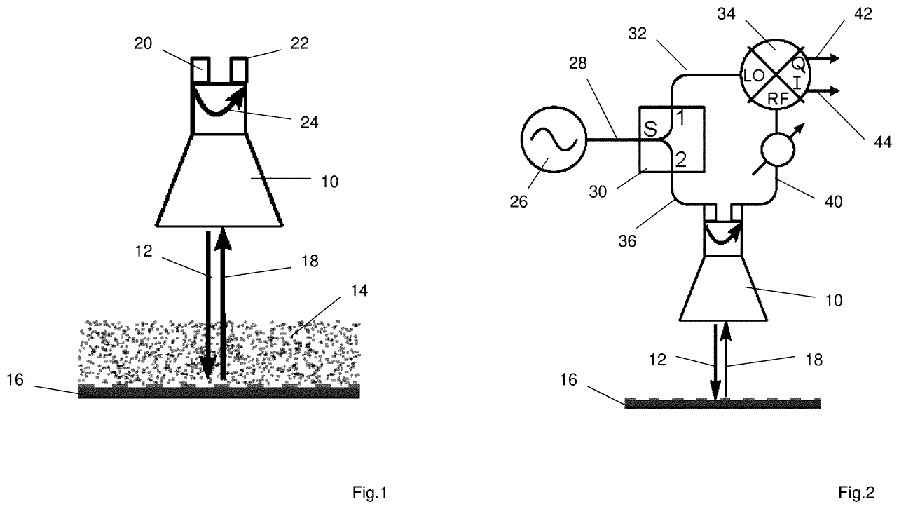

FIG. 2 shows the transmitting and receiving unit 10 with the reflector 16. FIG. 2 shows an oscillator 26, the output signal 28 of which is applied to a splitter 30. The splitter 30 splits the applied output signal 28 and applies a reference signal 32 to the Q/I modulator or respectively Q/I demodulator 34. The second output signal of the splitter 30 is applied to the transmitting and receiving unit 10 as input signals 36. The antenna of the transmitting and receiving unit 10 emits the applied input signals 36 as microwave radiation 12 and also receives the reflected microwave radiation 18. An input signal 40 is applied to the Q/I demodulator 34 via the output connection. The demodulator, the functional principle of which will be explained below, generates a Q signal 42 and an I signal 44.

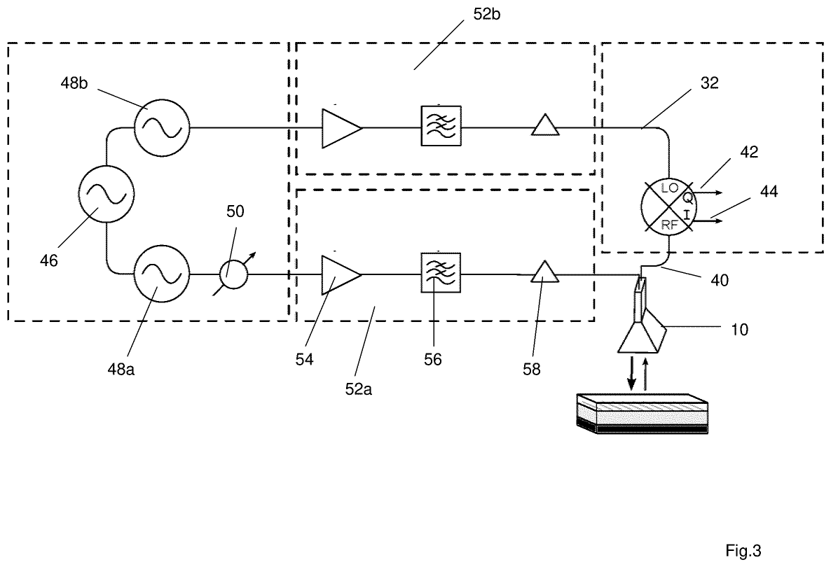

FIG. 3 shows the setup from FIG. 2 for the transmitting and receiving unit 10 in more detail. The oscillator 26 and splitter 30 can be built in detail from a reference oscillator 46, which feeds two PLLs (phase-locked loops) 48a, 48b. The phase-locked loops 48a, 48b are also referred to as “phase lock loops” and generate, starting from the reference oscillator 46, two synchronized oscillations, which corresponds to the two output signals of the splitter in FIG. 2. FIG. 3 additionally shows, in the path leading to the transmitting and receiving unit, a phase shifter 50, which can be incorporated, for example, into the phase-locked loop. The phase shifter 50 can be integrated into one or both of the phase-locked loops 48a, 48b. The task of the phase shifter 50 is to reduce an offset between the Q and I signals during setting or respectively calibration, which also reduces signal portions originating from the crosstalk.

FIG. 3 also shows a signal processor 52a and 52b, each of which consist of an amplification member 54, a low-pass filter 56, and an attenuation member 58. The signal processors 52a and 52b can in principle be designed differently. The processed signals are applied as a reference signal 32 and as an input signal 40 to the Q/I demodulator 34 to generate the Q and the I signals 42, 44.

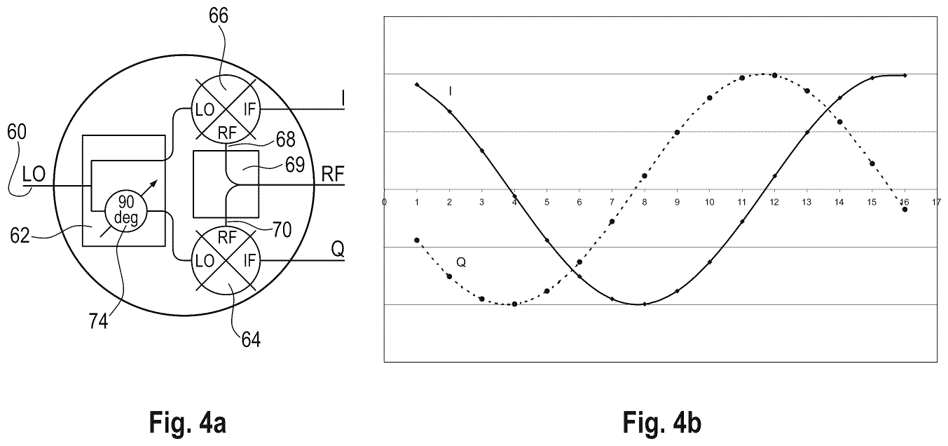

The Q/I demodulator 34 is explained in more detail with reference to FIGS. 4a and 4b. FIG. 4a shows an input signal 60, which is split in a splitter 62 into two signals which are applied to the mixer 64 and 66. The signal for the mixers 64 is shifted by 90° in the splitter 62 with a phase shifter 74; such a splitter is also referred to as a quadrature hybrid splitter. At the second input of the two mixers 64, 66, a reference signal RF is applied, which is divided in a splitter 69 into the reference signals 68 and 70. The mixers 66 and 64 output the I and Q signals. FIG. 4b shows the two I and Q signals shifted by 90° in relation to each other, which can be used for further evaluation.

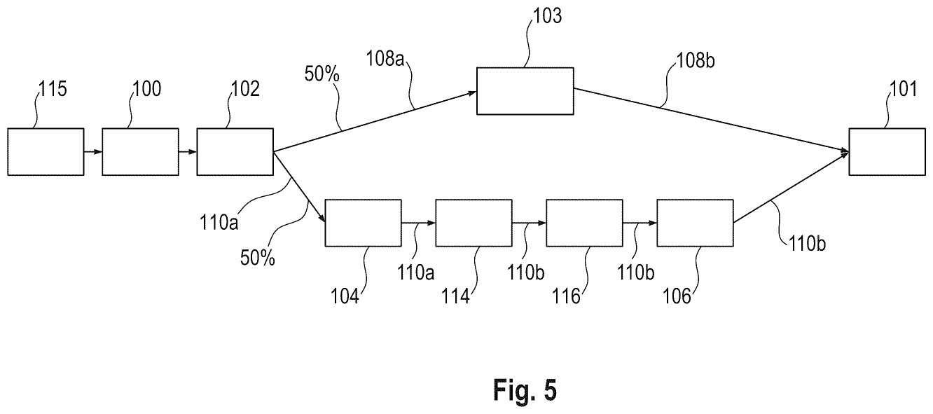

FIG. 5 shows a preferred embodiment from the prior art according to EP 1 407 254 B1. According to this, a switch 115 is provided, with which a microwave source 100 is switched.

The switch 115 defines the average frequency of a microwave source 100 changing linearly over time. A coupler 102 divides the signal into 50% in each case. Via the reference branch, the reference signal 108a runs to an attenuation and phase shifting apparatus 103, the output of which is applied as a reference signal 108b to the receiver 101. The phase shifting apparatus 103 compensates for the differences compared to the measured signal 110b both during an empty measurement and during a measurement with a measured item. Preferably, the compensation values are compared to each other to ascertain a signal change caused by the measured item. A measurement signal 110a goes to a transmitting antenna 104, from where it hits the sample or respectively the measurement object 114. Here, it then hits a polarizer 116 in order to hit the receiving antenna 106 as a reflected microwave signal, from where it is applied to the receiver 108. It can be clearly seen that both a transmitting antenna 104 and a receiving antenna 106 is to be provided.

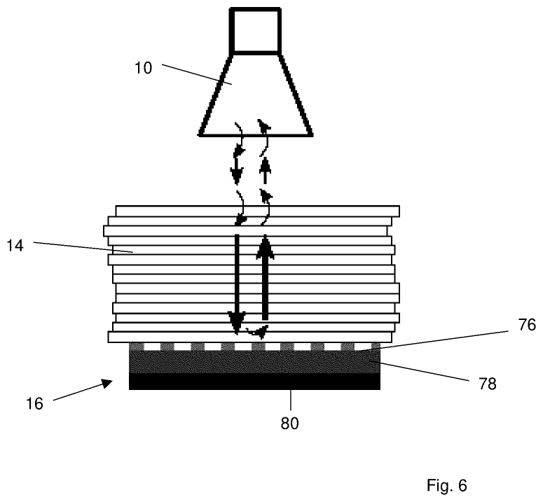

FIG. 6 shows the path of the microwave radiation in detail. The transmitting and receiving unit 10 emits microwave radiation (indicated by arrows), which first covers a distance in the air before it passes through the measured item 14. The measured item 14 lies on a reflector 16, which in turn is built from at least three layers. A polarizer 76, which consists, for example, of parallel electrically conductive metal rods/strands, a spacer 78, and a metal plate 80, on which the reflection of the microwave radiation that passed through takes place. The phase rotation takes place here with the passage through the polarizer 76.

The behavior of the signal at the reflector occurs, for example, as a lambda ¼ rotation. The occurring polarization of the incident microwave radiation can be broken down at any point in time into a component transverse and longitudinal to the lattice direction of the polarizer. The component parallel to the striations is reflected back with a reflection coefficient of −1, i.e., rotated by 180°. The components perpendicular to the polarizer, however, do not see it. This part of the radiation is then reflected by the metal plate with a conventional phase reversal of 180°. A change of the polarization by 90° in total results from this relationship.

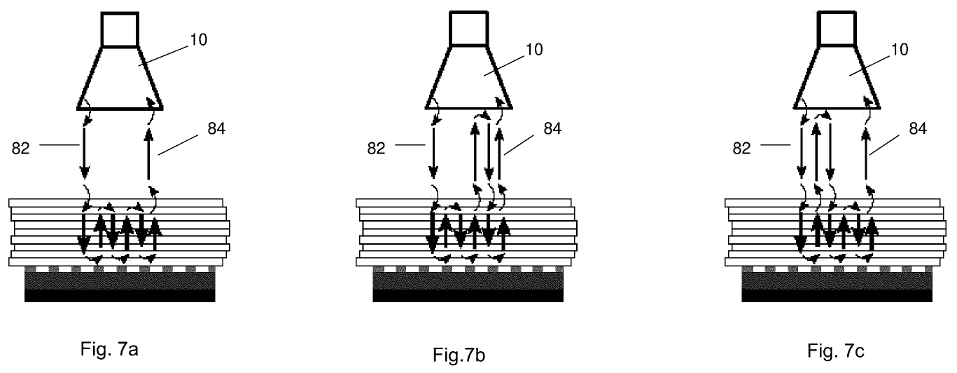

FIGS. 7a-7c show possible signal paths of the microwave radiation that are taken into account for an evaluation. The illustrated embodiments show the signal path of an incident beam 82 and a reflected beam 84. As shown in FIGS. 7a-c, incident microwave beam 82 and reflected microwave beam 84 are shown spatially spaced apart from each other. This is intended to indicate a superposition of multiple transmission paths, in which the microwave radiation can also run back and forth again within the measured item before it is reflected back to the transmitting and receiving unit 10.

FIGS. 7a and 7b show the case of the reflection of the microwave radiation to the transmitting and receiving unit 10. The incident microwave radiation is first reflected once within the measured item before it exits from it, is reflected by the transmitting and receiving unit 10 to finally be received as a measurement beam and evaluated. FIG. 7c shows the alternative, in which first the reflected microwave beam is reflected by the transmitting and receiving unit 10 and reflected back in order to then be thrown back and forth within the measured item and finally received by the transmitting and receiving unit. As is always typically with such considerations, the actual signal course of the measured signal is, of course, a superposition of all possible courses.

To improve the device provided according to the invention, a corresponding attenuator can be provided on the transmitting and receiving unit 10, which attenuates a reflection of the microwave radiation from the unit toward the measured item and back. In this way, the quality of the measurement signal is improved.

The evaluation of the Q signal 42 and the I signal 44 can take place directly separately with regard to the amplitude A and the phase φ. The following applies:

$$A = \sqrt{{I}^{2} + {Q}^{2}}$$

$$φ = arc t \text{?} \frac{Q}{I}$$

$$\text{?} \text{indicates text missing or illegible when filed}$$

Qualitatively, the independence of the Q/I signal from the operating point can be more easily understood when one considers that, with a decreasing output, the amplitude of the detected signals decreases and thus the amplitudes of the signals I and Q also decrease. When these decrease to the same extent, the quotient and thus the phase angle φ remain constant.

The key improvement occurs through the use of the transmitting and receiving unit 10 with the use of the individual, dually polarized antenna. According to the invention, a polarization rotation is provided here in order to receive the reflected signals. Since the crosstalk signals which are applied between the input and the output of the signals form a direct-current offset, this can be set during the initial calibration of the system.

### LIST OF REFERENCE SIGNS

10 Transmitting and receiving unit
12 Microwave radiation
14 measurement object
16 Reflector
18 Reflected microwave radiation
20 Input signal
22 Output signal
24 Arrow/crosstalk/crosstalk signal
26 Oscillator
28 Output signal
30 Splitter
32 Reference signal
34 Q/I demodulator
36 Input signal
40 Input signal
42 Q signal
44 I signal
46 Reference oscillator
48a, b Phase-locked loops
50 Phase shifter
52a, b Signal processor
54 Amplification member
56 Low-pass filter
58 Attenuation member
60 Input signal
62 Splitter
64 Mixer
66 Mixer
68 Reference signal
69 Splitter
70 Input signal
72 Reference oscillator
74 Phase shifter
76 Polarizer
78 Spacer
80 Metal plate
82 Incident microwave beam
84 Reflected microwave beam
100 Microwave source
102 Coupler
103 Attenuation and phase shifting apparatus
104 Transmitting antenna
106 Receiving antenna
108 Receiver
108a Reference signal
110a Measurement signal
110b Measurement signal
114 measurement object
115 Switch
116 Polarizer

1-12. (canceled)

13. A device for transmission measurement of a measurement object by measuring and evaluating reflected microwaves, comprising:
a microwave generator configured to generate radiation;
a transmitting and receiving unit connected to the microwave generator and comprising an individual, dually polarized antenna, wherein the transmitting and receiving unit is configured to emit microwave radiation onto the measurement object and further configured to receive radiation reflected from the measurement object;
a reflector comprising a polarizer configured to rotate a polarization of the radiation reflected from the measurement object in relation to incident radiation, wherein the reflector is positioned on a side of the measurement object facing away from the transmitting and receiving unit; and
a modulator for the transmitting and receiving unit that is configured to determine at least one of: (i) an amplitude; and (ii) a phase position between the emitted and reflected radiation,
wherein the modulator is configured as an Q/I modulator.

14. The device according to claim 13, wherein a reference signal is applied at the modulator, and wherein the reference signal originates from the microwave generator.

15. The device according to claim 13, wherein the microwave generator further comprises an oscillator configured to generate a signal that is applied to a splitter, and wherein the splitter is configured to generate an output signal that acts as a reference signal and is further an input signal to the transmitting and receiving unit.

16. The device according to claim 15, further comprising a phase-locked loop (PLL) for at least one of: (i) the reference signal; and (ii) the input signal of the transmitting and receiving unit.

17. The device according to claim 15, further comprising a signal processor for the at least one of: (i) the reference signal; and (ii) the input signal of the transmitting and receiving unit.

18. The device according to claim 17, wherein the signal processor comprises at least one of: (i) an amplifier assembly; (ii) a low-pass assembly; and (iii) and attenuator assembly.

19. The device according to claim 17, further comprising a phase shifter for the at least one of: (i) the reference signal; and (ii) the input signal of the transmitting and receiving unit.

20. The device according to one of claim 13, wherein the reflector comprises a ¼ (2n+1) lambda waveplate.

21. The device according to claim 13, wherein the Q/I modulator comprises two mixers which are in quadrature to each other.

22. The device according to claim 21, wherein the Q/I modulator is configured to determine at least one of: (i) a signal phase; and (ii) a signal amplitude regardless of an operating point.

23. A method for transmission measurement of a measurement object by measuring and evaluating reflected microwaves, comprising:
structuring a microwave generator to generate radiation;
structuring a transmitting and receiving unit to be connected to the microwave generator and comprise an individual, dually polarized antenna, wherein the transmitting and receiving unit is configured to emit microwave radiation onto the measurement object and further configured to receive radiation reflected from the measurement object;
structuring a reflector to comprise a polarizer configured to rotate a polarization of the radiation reflected from the measurement object in relation to incident radiation, wherein the reflector is positioned on a side of the measurement object facing away from the transmitting and receiving unit; and
structuring a modulator for the transmitting and receiving unit that is configured to determine at least one of: (i) an amplitude; and (ii) a phase position between the emitted and reflected radiation, wherein the modulator is configured as an Q/I modulator.

24. The method according to claim 23, further comprising generating a reference signal from the microwave generator and applying the reference signal to the Q/I modulator.
